(19) United States
(12) Patent Application Publication
(10) Pub. No.: US 2009/0179760 A1
(43) Pub. Date: Jul. 16, 2009

(54) CASTER SYSTEM ACTIVATOR

(76) Inventors: Joseph F. Nebolon, Del Mar, CA (US); Dante A. Galli, Vista, CA (US); Cory McCluskey, Carmel Valley, CA (US)

Correspondence Address: NYDEGGER & ASSOCIATES, 348 OLIVE STREET, SAN DIEGO, CA, 92103, US

(21) Appl. No.: 11/972,436

(22) Filed: Jan. 10, 2008

(51) Int. Cl. G08B 13/14

(52) U.S. Cl. 340/568.5

(57) ABSTRACT

A system provides on-demand operation of a mobile electronic device mounted on a vehicle such as a shopping cart. The system includes a detector for sensing movement of the vehicle and device. Further, the system includes a controller electronically connected to the detector and to the device. With this interconnection, the controller may switch the device between an operating state and a resting state. Specifically, the controller establishes the operating state upon initiation of movement of the device. Also, the system is provided with a timer that is connected to the controller for switching the device to the resting state after expiration of an uninterrupted pre-determined time interval.

### FIELD OF THE INVENTION

The present invention pertains generally to electronic devices used on vehicles such as shopping carts. More particularly, the present invention pertains to a system that detects when a vehicle is in use. The present invention is particularly, but not exclusively, useful as a system that provides on-demand operation of electronic devices in response to movement of a vehicle.

### BACKGROUND OF THE INVENTION

In many retail shopping areas, shopping carts that include electronic devices are provided to the public. For instance, electronic identifiers may be mounted on carts in order to: 1) provide for shopping cart inventory control and maintenance; 2) prevent shopping cart theft; and 3) monitor customer shopping habits. In addition to the above-mentioned applications, electronic devices that provide coupons, directions or shopping assistance may also be mounted on shopping carts.

Due to their use on mobile carts, electronic devices, whether RF transceivers, magnetic sensors or other instruments, must operate on battery power. Unfortunately, batteries that provide sufficient power and life for use on shopping carts are expensive. Also, such batteries often present maintenance problems in the field. Further, the required battery replacement or recharging process may make the use of batteries on carts labor prohibitive. This is particularly true for RF transceivers that consume significant power on a frequent basis to detect local RF signals.

In view of the problems associated with batteries used on mobile shopping carts, the present invention contemplates selectively powering cart-mounted electronic devices. Specifically, because a cart-mounted electronic device is generally only in use when the cart is in motion, the device may be switched to a sleep state when the cart is not in use. In this manner, the power used by a cart is greatly reduced. As a result, the battery replacement or recharging frequency is also greatly reduced.

In light of the above, it is an object of the present invention to provide a system for providing an on-demand operation of a mobile electronic device. Another object of the present invention is to provide a system that selectively switches a mobile electronic device between an operating state and a resting state. Yet another object of the present invention is to provide a system for operating cart-mounted electronic devices that can be easily incorporated for use with the electronic devices and related systems. Another object of the present invention is to provide an electronic device operating system that is easy to use, simple to manufacture, and comparatively cost effective.

### SUMMARY OF THE INVENTION

In accordance with the present invention, a system provides an on-demand operation of a mobile electronic device is mounted on a shopping cart. The purpose of the system is to reduce the power used by the device. Specifically, the system virtually eliminates the power used by the device when the shopping cart is not in use. Preferably, the electronic device and the system are mounted to a caster on the vehicle.

For the present invention, the system includes a detector for sensing movement of the device. For instance, the detector may be an accelerometer, a shock sensor, a moving magnet or a light sensor. Further, the system includes a controller electronically connected to the detector and to the device. With this interconnection, the controller is able to switch the device between an operating state and a resting state. For example, the controller switches the device to the operating state upon initiation of movement of the device, as sensed by the detector. Also, the system is provided with a timer that is connected to the controller. As designed, the timer causes the controller to switch the device to the resting state after the expiration of an uninterrupted pre-determined time interval of non-movement of the electronic device, such as less than five minutes.

As envisioned for the present invention, the electronic device includes a battery. Further, the battery is connected to the controller to provide power for the device during the operating state. Depending on the intended use, the electronic device may be an RF transceiver, a magnetic sensor, or another device used on shopping carts.

During operation of the system, a cart may initially be at a standing position with the electronic device in the resting state, which is a very low power sleep state. When the cart is moved, the detector senses movement of the electronic device and communicates the movement to the controller. In response, the controller wakes the electronic device from the resting state and switches the electronic device to the operating state, i.e., a full power state. Thereafter, the detector continues to monitor movement of the electronic device. Whenever the device becomes still, the timer measures the time until the device is moved again. If the time exceeds a pre-determined time interval, then the controller switches the electronic device back to the resting state.

In certain cases, turning the electronic device on-and-off frequently could interrupt various electronic device functions. In other cases, frequently switching the electronic device between states would be viable. Therefore, it is envisioned that the timer and/or controller may be manipulated to adjust the length of the predetermined time interval.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a shopping cart equipped with an electronic device and the system of the present invention;

FIG. 2 is a perspective view of the electronic device and the system mounted on a caster from the shopping cart of FIG. 1; and

FIG. 3 is a schematic diagram of the component elements of the system of the present invention.

### DESCRIPTION OF THE PREFERRED EMBODIMENTS

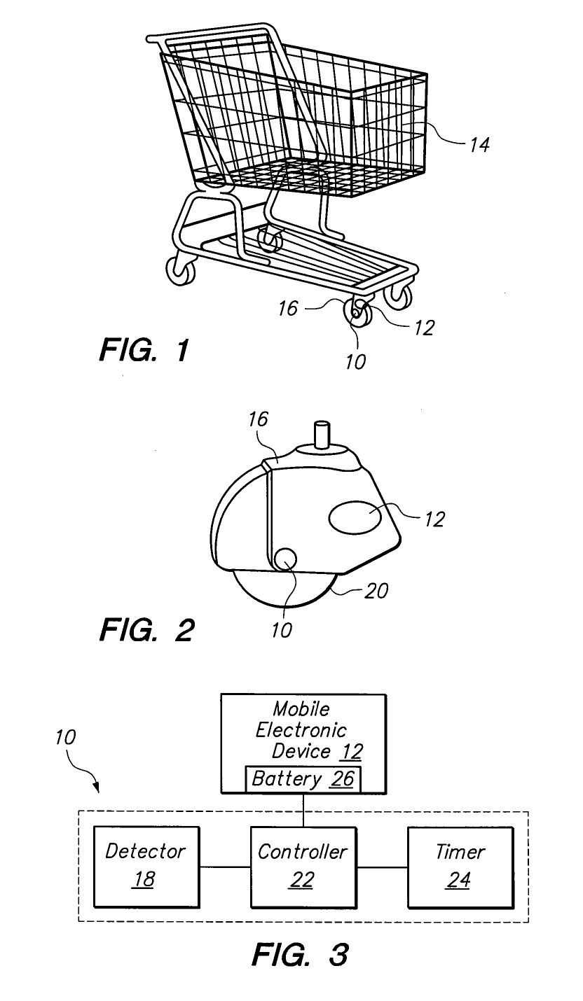

Referring initially to FIG. 1, a system 10 for providing an on-demand operation of a mobile electronic device 12 is shown. As shown, both the system 10 and electronic device 12 are mounted to a vehicle 14, for example, a shopping cart. More specifically, both the system 10 and the electronic device 12 are mounted to caster 16 on the shopping cart 14. Depending on the desired use of the cart 14, the electronic device 12 may be an RF transceiver, a magnetic sensor, or another device used on a cart 14.

Referring now to FIG. 2, the system 10 and device 12 are more clearly illustrated as being mounted on the caster 16. In FIG. 2, the electronic device 12 includes a transceiver for communicating the position of the caster 16 relative to a secured area. Such an electronic device 12 allows the cart 14 to be disabled if pushed outside of its secured area.

Referring now to FIG. 3, the components of the system 10 are illustrated. As shown, the system 10 includes a detector 18 for sensing movement of the device 12. Depending on the desired operation of the system 10, the detector 18 may be an accelerometer, a shock sensor (mechanical switch or MEMS), a light sensor for measuring a change in lighting, a moving magnet mounted on the wheel 20 (shown in FIG. 2) of the caster 16, or other mechanisms for sensing movement of the cart 14 and device 12.

In FIG. 3, the system 10 is shown to include a controller 22 that is electronically interconnected to the detector 18 and the electronic device 12. For purposes of the present invention, this interconnection allows the controller 22 to switch the electronic device 12 between a resting state and an operating state that is established upon movement of the electronic device 12. Also, the system 10 includes a timer 24 connected to the controller 22 for switching the electronic device 12 to the resting state. Specifically, the timer 24 and controller 22 cooperate to switch the electronic device 12 to the resting state when the device 12 has remained still for a time equal to an uninterrupted pre-determined time interval. Measurement of the time interval starts when the device 12 stops moving and is interrupted when the device 12 restarts movement. When movement of the device 12 interrupts the time measurement before the time reaches the pre-determined time interval, the time measurement is reset. Accordingly, measurement of the time begins when the device 12 becomes still again. As shown in FIG. 3, the electronic device 12 includes a battery 26 to provide power for the device 12.

To begin operation of the system 10, the cart 14 may be considered to be initially at rest. Thereafter, when the cart 14 is moved, the caster 16 necessarily moves. At that time, the detector 18 of the system 10 senses the movement of the caster 16 and the device 12 and communicates a “dynamic” signal to the controller 22. When the controller 22 receives the signal from the detector 18, it switches the electronic device 12 to the operating state in which the device 12 uses its full power requirement from the battery 26. Thereafter, the detector 18 continues to monitor the dynamic/static state of the cart 14 and device 12. When the device 12 becomes still, the detector 18 sends a “static” signal to the controller 22. In response, the controller 22 operates the timer 24 to measure the length of time that the device 12 remains static. When the time exceeds a predetermined time interval, the controller 22 switches the electronic device 12 to the resting state in which the device 12 uses a greatly reduced amount of power from the battery 26. Then, the detector 18 again monitors the device 12 for movement.

If the device 12 remains static for a period of time less than the predetermined time interval, then the controller does not switch the device 12. Instead, the device 12 remains in the operating state and the detector 18 monitors the device 12 to determine if the device 12 has become still again.

While the particular Caster System Activator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for providing an on-demand operation of a mobile electronic device which comprises:
a detector for sensing movement of the device;
a controller electronically connected to the detector, and to the device, for switching the device between an operating state and a resting state, wherein the operating state is established upon initiation of a movement of the device; and
a timer connected to the controller for switching the device to the resting state after expiration of an uninterrupted pre-determined time interval, wherein the pre-determined time interval starts when the device stops, and wherein the pre-determined time interval is interrupted whenever a movement of the device is initiated.

2. A system as recited in claim 1 further comprising a vehicle having a caster to provide for movement of the vehicle, wherein the electronic device is mounted on the vehicle.

3. A system as recited in claim 2 wherein the vehicle is a shopping cart.

4. A system as recited in claim 1 wherein the electronic device includes a battery, and the controller is connected to the battery to provide power for the device during the operating state.

5. A system as recited in claim 4 wherein the electronic device is an RF transceiver.

6. A system as recited in claim 4 wherein the electronic device is a magnetic sensor.

7. A system as recited in claim 1 wherein the detector is an accelerometer.

8. A system as recited in claim 1 wherein the detector is a shock sensor.

9. A system as recited in claim 1 wherein the detector is a light sensor.

10. A system as recited in claim 1 wherein the pre-determined time interval is selected to be less than five minutes.

11. A system for minimizing battery power used by an electronic device mounted on a vehicle which comprises:
a detector for sensing movement of the vehicle;
a means for switching the device from a resting state to an operating state in response to the detector sensing a movement of the vehicle; and
a means for switching the device from the operating state to the resting state in response to the detector sensing an absence of movement of the vehicle for a predetermined time interval.

12. A system as recited in claim 11 wherein the vehicle is a shopping cart.

13. A system as recited in claim 11 wherein the electronic device is an RF transceiver.

14. A system as recited in claim 11 wherein the electronic device is a magnetic sensor.

15. A system as recited in claim 11 wherein the detector is an accelerometer.

16. A system as recited in claim 11 wherein the detector is a shock sensor.

17. A system as recited in claim 11 wherein the detector is a light sensor.

18. A method for providing an on-demand operation of a mobile electronic device which comprises the steps of:
connecting the electronic device to a vehicle;
mounting a system to the vehicle, with said system including a detector for sensing movement of the vehicle, a controller electronically connected to the detector and to the device, and a timer connected to the controller;
operating the system to sense movement of the vehicle; and
selectively switching the electronic device between a resting state and an operating state, wherein the operating state is established upon initiation of a movement of the vehicle, and wherein the resting state is established upon expiration of an uninterrupted pre-determined time interval, wherein the pre-determined time interval starts when movement of the device stops, and wherein the pre-determined time interval is interrupted whenever movement of the device is initiated.

19. A method as recited in claim 18 wherein the electronic device includes a battery, and the controller is connected to the battery to provide power for the device during the operating state.

20. A method as recited in claim 18 wherein the vehicle is a shopping cart.
